(19) United States
(12) Patent Application Publication
(10) Pub. No.: US 2026/0101136 A1
(43) Pub. Date: Apr. 9, 2026

(54) EARPHONE

(71) Applicant: Harman International Industries, Incorporated, Stamford, CT (US)

(72) Inventors: Shaomin WANG, Shenzhen (CN); Yulian CHEN, Shenzhen (CN); Pingdong YANG, Shenzhen (CN); Jinhua ZOU, Shenzhen (CN)

(73) Assignee: Harman International Industries, Incorporated, Stamford, CT (US)

(21) Appl. No.: 19/483,484

(22) Filed: Nov. 11, 2025

Related U.S. Application Data
(63) Continuation of application No. PCT/CN2023/097052, filed on May 30, 2023.

(51) Int. Cl. H04R 1/28; H04R 1/08; H04R 1/10; H04R 5/033

(52) U.S. Cl. CPC H04R 1/2884; H04R 1/08; H04R 1/1016; H04R 1/1075; H04R 1/1083; H04R 5/033; H04R 2410/05; H04R 2410/07; H04R 2420/07

(57) ABSTRACT

An earphone includes a housing and a microphone. The earphone contains a speaker therein and defines a cavity and an elongated opening. The elongated opening is in communication with the cavity and with an atmosphere around the earphone. The is microphone provided in the housing. The microphone is exposed to or is in communication with the cavity, and being configured to capture external sound through the cavity and the elongated opening.

### CROSS-REFERENCE TO RELATED APPLICATIONS

This application is a continuation of International Application No. PCT/CN2023/097052, filed on May 30, 2024. The disclosures of the above applications are incorporated herein by reference.

### FIELD

The present disclosure relates to an earphone, and more specifically, to an earphone designed to reduce wind noise.

### BACKGROUND

The statements in this section merely provide background information related to the present disclosure and may not constitute prior art.

As everyday accessories, wireless active noise cancelling (ANC) earphones have become more and more popular among users around the world. The earphones are designed and engineered to reduce unwanted ambient noise, such as background conversations, traffic noise, and other environmental sounds. This is typically achieved by using a microphone to detect external noises, and a speaker to generate an inverse sound wave to cancel out the unwanted noise.

However, wind noise is a common issue that affects the overall auditory experience for users of ANC earphones. Wind noise occurs when air flows over the microphone of the earphone, creating a pressure difference inside and outside the earphone cavity. This pressure difference may affect the microphone's ability to accurately capture external sounds, resulting in wind noise and a reduction in ANC performance.

While several approaches have been proposed to address wind noise in ANC earphones, there is a persistent demand for a more effective solution that reduces wind noise in ANC earphones without compromising the performance and/or design of the earphone.

### SUMMARY

This section provides a general summary of the disclosure and is not a comprehensive disclosure of its full scope or all of its features.

According to one aspect of the present disclosure, an earphone is provided that includes a housing and a microphone. The housing contains a speaker therein and defines a cavity and an elongated opening. The elongated opening allows the cavity to be in communication with an atmosphere around the earphone. The microphone is provided in the housing. The microphone is exposed to or communicating with the cavity, and being configured to capture external sound through the cavity and the elongated opening.

According to another aspect of the disclosure, the housing comprises a main housing and a rear cover. The elongated opening is a gap or slit defined between the main housing and the rear cover.

According to another aspect of the disclosure, the elongated opening has a length 10 times or more greater than its width. Optionally, the elongated opening has a length 20 times or more greater than its width, and still optionally, the elongated opening has a length 50 times or more greater than its width.

According to another aspect of the disclosure, the gap or slit has a width of 0.08-0.5 mm, 0.1-0. 3mm, or 0.15-0.25 mm.

According to another aspect of the disclosure, the gap or slit has a length of 8-10 mm, 7-11 mm, 6-12 mm, 9-12 mm, 12-16 mm, 16-20 mm, 20-24mm or 24-28mm.

According to another aspect of the disclosure, the gap or slit extends over an entire peripheral extension of the cavity.

According to another aspect of the disclosure, the earphone comprises an inner cover that is located in and attached to the housing. The inner cover comprises a concave portion, and the cavity is defined between the housing and the concave portion of the inner cover.

According to another aspect of the disclosure, the concave portion comprises a bottom wall and a side wall. The bottom wall comprises an opening therein, and the microphone is exposed to or communicates with the cavity through the opening in the bottom wall.

According to another aspect of the disclosure, the earphone comprises a main body having a front side and a rear side. The cavity is located in a peripheral area of the main body on the rear side.

According to another aspect of the disclosure, the cavity has a volume of about 25 mm3, a volume of 20-30 mm3, or a volume of 15-35 mm3.

According to another aspect of the disclosure, the cavity extends along a circumference of the main body over an angle of about 90 degrees, an angle of 80-100 degrees, or 60-120 degrees.

According to another aspect of the disclosure, the earphone comprises a main body and a stem extending from the main body and connected to the main body at its stem base, and the cavity extends around the stem base.

According to another aspect of the disclosure, the cavity and/or the elongated opening are located on a leeward side of the earphone.

According to another aspect of the disclosure, the elongated opening is offset from the microphone.

According to another aspect of the disclosure, the microphone is located adjacent to one of circumferential ends of the cavity.

According to another aspect of the disclosure, the microphone is an ANC microphone.

According to another aspect of the disclosure, the earphone is a pair of TWS earbuds.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The present disclosure will be better understood by reference to the following drawings and description. The components shown in the drawings are not necessarily to scale, instead, emphasis should be placed upon the principles illustrated by the disclosure. Moreover, in the figures, like reference numerals designate like parts throughout the drawings.

FIG. 1 illustrates a perspective view of an earphone according to one or more embodiments of the present disclosure;

FIG. 2 illustrates a cross-sectional view of the earphone of FIG. 1;

FIG. 3 is an enlarged view of a dashed area in FIG. 2; and

FIG. 4 illustrates a perspective view of an earphone of FIG. 1, with a rear cover removed to show the internal structure of the earphone.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, various embodiments of the present disclosure will be described in more detail with reference to the accompanying drawings.

As used herein, the singular forms “a”, “an” and “the” are intended to include the plural forms as well, unless the context clearly indicates otherwise. The terms “comprises”, “comprising”, “includes” and/or “including”, as used herein, specify the presence of stated features, integers, steps, operations, elements, and/or components, but do not preclude the presence or addition of one or more other features, integers, steps, operations, elements, components, and/or combinations thereof. As used herein, the term “and/or” and the symbol “/” are meant to include any and all combinations of one or more of the associated listed items. Additionally, while the terms first, second etc., may be used herein to describe various elements, components, steps or calculations, these elements, components, steps, or calculations should not be limited by these terms, rather, these terms are only used to distinguish one element, component, step or calculation from another. For example, a first component may be referred to as a second component, similarly a first calculation may be referred to as a second calculation; likewise, a first step may be referred to as a second step, all without departing from the scope of this disclosure.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The present disclosure provides an earphone comprising a structure designed to reduce wind noise. The structure comprises a cavity defined within a housing of the earphone; an elongated opening provided in the housing, communicating the cavity with an atmosphere around the earphone; and a microphone exposed to or communicating with the cavity and configured to capture external sound through the cavity and the elongated opening.

With a combination of the cavity and the elongated opening, wind noise may be reduced as the wind flowing across the earphone affects the microphone in a less direct and more diffused manner.

In one or more embodiments of the present disclosure, the elongated opening is a gap or slit defined between the main housing and the rear cover. The gap or slit may have a width of 0.08-0.5 mm, 0.1-0.3 mm, or 0.15-0.25 mm and it may have a length of 8-10 mm, 7-11 mm, 6-12 mm, 9-12 mm, 12-16 mm, 16-20 mm, 20-24 mm or 24-28 mm. The elongated opening is formed by a gap or slit defined between the main housing and the rear cover and no separate opening in the housing is desired. This simplifies the manufacturing of the earphone. Additionally, the gap or slit has so small width that it may allow the environmental sound to pass through while inhibiting external water or debris from entering the cavity without a need for a mesh covering the gap or slit. This further simplifies the manufacturing of the earphone.

In one or more embodiments of the present disclosure, the cavity may have a volume of about 25 mm3, a volume of 20-30 mm3, or a volume of 15-35 mm3. A large cavity can provide a large buffer zone that reduces the pressure difference between the inside and outside of the earphone when wind flows around the earphone.

In one or more embodiments of the present disclosure, the cavity is located in a peripheral area on a rear side of the earphone, surrounding a central portion of the earphone. The cavity may extend along a circumference of the earphone over an angle of about 90 degrees, an angle of 80-100 degrees, 60-120 degrees or even larger. The gap or slit may extend over an entire peripheral extension of the cavity.

Providing the cavity in the peripheral area on the rear side of the earphone where normally no or very few elements are provided allows for a relatively large volume cavity without enlarging the volume of the entire earphone and/or compromising or substantially altering its design.

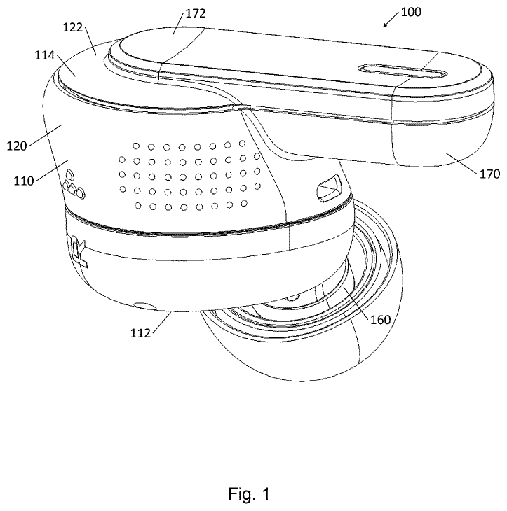

FIG. 1 illustrates a perspective view of an earphone 100 according to one or more embodiments of the present disclosure. As shown, the earphone 100 is a TWS earbud comprising a main body 110, an ear tip 160, and a stem 170. The main body 110 features a front or first side 112 and a rear or second side 114, with the ear tip 160 extending from the front or first side 112 of the main body 110 and the stem 170 located on the rear or second side 114 of the main body 110. The stem 170 comprises a stem base 172, which is situated at a central portion of the main body 110. The main body 110 comprises a main housing 120 and a rear cover 122. The main housing 120 and the rear cover 122 are mated together to enclose or define a space for accommodating the earphone's electronic components therein. The main housing 120 and the rear cover 122 together may be referred to as a housing or an outer housing of the main body 110. When the earphone 100 is worn by a user, the ear tip 160 is at least partially inserted into an ear canal of the user, allowing the sound produced by a speaker assembly of the earphone 100 to travel through a tunnel in the ear tip 160 into the ear canal of the user.

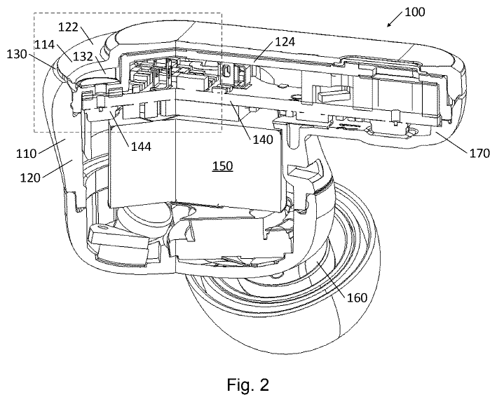

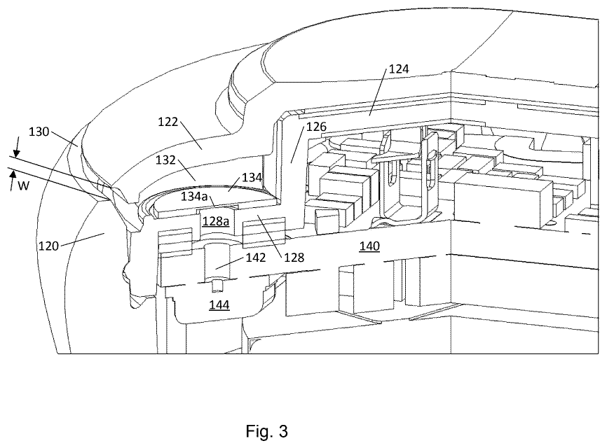

FIG. 2 illustrates the same perspective view of the earphone 100 as FIG. 1, but with a portion removed to reveal its internal structure. FIG. 3 is an enlarged view of a dashed area in FIG. 2. As shown, the main body 110 comprises electronic components located in the space defined by the main housing 120 and the rear cover 122, including a speaker assembly 150, a printed circuit board (PCB) 140, and a microphone 144. The main body 110 further comprises an inner cover 124 located in the space defined by the main housing 120 and the rear cover 122. The inner cover 124 comprises a concave portion concaved inwardly, i.e. towards the center of the main body 110. The concave portion comprises a flat bottom wall 128 and a side wall 126 extending from the bottom wall 128 in a direction substantially perpendicular to the bottom wall 128. The inner cover 124 is attached to the main housing 120 and/or the rear cover 122, defining a cavity 132 between the main housing 120, the rear cover 122, and the concave portion of the inner cover 124. In the example shown, the side wall 126 is attached to the rear cover 122 and the bottom wall 128 is attached to the main housing 120, and the cavity 132 is defined between the main housing 120, the rear cover 122, and the bottom wall 128 and the side wall 126 of the inner cover 124.

The PCB 140 is positioned and orientated relative to the inner cover 124 so that it is parallel to and adjacent to the bottom wall 128 of the inner cover 124. The microphone 144 is attached to the PCB 140 on a side opposite to the bottom wall 128 of the inner cover 124. The PCB 140 comprises an opening 142, and the bottom wall 128 of the inner cover 124 comprises an opening 128a. The microphone 144, the opening 142 in the PCB 140, and the opening 128a in the inner cover 124 are aligned with one another, permitting the microphone 144 to be exposed to or communicate with the cavity 132 and capture sound from the cavity 132 through the opening 142 in the PCB 140 and the opening 128a in the inner cover 124. A mesh 134 is provided in the cavity 132, covering the aligned openings 142 and 128a, for dissipating any wind. The mesh 134 has a thinned region 134a, which is aligned with the openings 142 and 128a.

The main housing 120 and the rear cover 122 are shaped and dimensioned so that a gap or slit 130 is formed between the main housing 120 and the rear cover 122 in the region of the cavity 132. The gap or slit 130 opens to the cavity 132, allowing the cavity 132 to communicate with the surrounding atmosphere through the gap or slit 130. The gap or slit 130 is located near or adjacent to a free edge or a distal edge of the bottom wall 128, away from the side wall 126. In one or more embodiments of the present disclosure, the gap or slit 130 may have a width W of 0.08-0.5 mm, 0.1-0.3 mm, or 0.15-0.25 mm. In one or more further embodiments of the present disclosure, the gap or slit 130 may have a width W of about 0.2 mm.

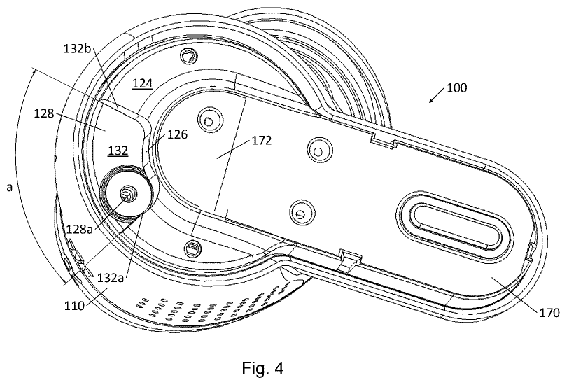

FIG. 4 illustrates a perspective view of the earphone 100, with a rear cover removed to show the internal structure of the earphone 100, such as the shape or size of the cavity 132. As shown, the cavity 132 is located in a peripheral area on the rear or second side 114 of the main body 110, surrounding a central portion, such as the stem base 172 of the main body 110. The cavity 132 extends along the circumference of the main body 110 over an angle a. In one or more embodiments of the present disclosure, the gap or slit 130 extends over an entire peripheral dimension of the cavity, i.e., extending over the entire range of the angle a.

By providing the cavity 132 in the peripheral area on the rear or second side 114 of the main body 110 where normally no or very few elements are provided, it is possible to provide a cavity with a relatively large volume without increasing the entire earphone's size and/or significantly altering its design. In the example illustrated, the cavity 132 has a volume of 24.8 mm3. In one or more other embodiments, the cavity 132 may have a volume of about 25 mm3, a volume of 20-30 mm3, a volume of 15-35 mm3, or a volume of 10-40 mm3. As shown in FIG. 4, the cavity 132 extends along the circumference of the main body 110 over an angle a of about 90 degrees. In one or more other embodiments, the cavity may extend along the circumference of the main body over a different angle a, such as an angle of 80-100 degrees, 70-110 degees, or 60-120 degrees. In one or more further embodiments, the cavity may extend along the circumference of the main body over a larger angle a, such as an angle of 90-120 degrees, 120-160 degrees, 160-200 degrees or 200-240 degrees or even 240-280 degrees. Correspondingly, the cavity may have a larger volume, such as a volume of 25-35 mm3, 35-50 mm3, 50-80 mm3, or 80-100 mm3.

In the example illustrated, the gap or slit 130 may extend over an entire peripheral dimension of the cavity and may have a length of about 9 mm. In one or more embodiments of the present disclosure, the gap or slit 130 may extend over an entire peripheral dimension or a substantial portion of the peripheral dimension of the cavity, such as 50%-65%, 65-80%, or 80%-100% of the peripheral dimension of the cavity, and/or may have a length of 8-10 mm, 7-11 mm, 6-12 mm, 9-12 mm, 12-16 mm, 16-20 mm, 20-24 mm or 24-28 mm.

The combination of the cavity 132 and gap or slit 130 provides a pathway that allows the microphone 144, which is exposed to or communicates with the cavity 132, to capture environmental sound from outside of the earphone 100. The relatively large volume of the cavity also acts as a large buffer zone, reducing the pressure difference between the inside and outside of the earphone when wind flows around the earphone. With the elongated length of the gap or slit 130, the wind flowing across the earphone may affect the space inside the cavity and near the microphone in a less direct and more diffused manner. Thus, the relatively large volume of the cavity and/or the elongated length of the gap or slit may assist in reducing wind noise, and help the microphone to capture the external sounds more accurately when wind flows across the earphone.

The earphone of the present disclosure offers several technical advantages. It reduces wind noise and accurately captures sound, even when wind flows across the earphone. This is achieved without enlarging the total size of the entire earphone or compromising its design. Additionally, the gap or slit 130 is sized (small width) that it allows environmental sounds to pass through while inhibiting external water or debris from entering the cavity, without a need for a mesh covering the gap or slit. The rear cover 122 and main housing 120 are designed so that the small gap or slit 130 is not noticeable from the outside, resulting in an improved appearance of the earphone.

In the one or more embodiments illustrated, the microphone 144 is an ANC microphone. The microphone 144 in the earphone 100 can capture ambient noise more accurately even when wind flows across the earphone. This assists the earphone in generating necessary counteracting sound waves to cancel out unwanted noise. By reducing the impact of wind noise upon the microphone 144, the overall ANC performance is improved, providing a better auditory experience for the user. The present disclosure is not limited thereto. In one or more embodiments of the present disclosure, the microphone may be a call microphone. The call microphone may be able to capture the user's voice more clearly or accurately when there is wind blowing across the earphone.

In the one or more embodiments illustrated, the cavity 132 is located in the peripheral area on the rear or second side 114 of the main body 110, surrounding a central portion of the earphone. The present disclosure is not limited thereto. In one or more embodiments of the present disclosure, the cavity may be provided at any suitable location. In the illustrated embodiments, the cavity 132 is defined between a concave portion of the inner cover, a main housing and a rear cover, and the concave portion comprises a flat bottom wall 128 and a side wall 126 extending from the bottom wall 128 in a direction substantially perpendicular to the bottom wall 128. The present disclosure is not limited thereto, in one or more other embodiments of the present disclosure, the cavity may be defined by any suitable structure in the earphone and/or the concave portion of the inner cover 124 may have any suitable shape. In one or more embodiments, the side wall may be inclined with respect to the bottom wall.

In the one or more embodiments illustrated, the microphone 144 is exposed to or communicates with the cavity 132 through the opening 142 in the PCB 140 and the opening 128a in the inner cover 124 which are aligned with one another. The present disclosure is not limited thereto. In one or more embodiments of the present disclosure, the microphone may be exposed to or communicates with the cavity through any suitable means.

In the one or more embodiments illustrated, a gap or slit 130 is provided between the rear cover 122 and the main housing 120 for communicating the cavity 132 with the surrounding atmosphere. The present disclosure is not limited thereto, and in one or more embodiments of the present disclosure, an elongated opening may be used to communicate the cavity with the surrounding atmosphere. The elongated opening may be an opening formed in the rear cover or the main housing or any suitable housing member. The elongated opening may have a relatively large length as compared to its width. In one or more embodiments, the elongated opening may have a length 10 times or more greater than its width. In one or more other embodiments, the elongated opening may have a length 20 times or more greater than its width. In one or more other embodiments, the elongated opening may have a length 50 times or more greater than its width.

As shown in the figures, the elongated opening (gap or slit 130) is located near or adjacent to a free or distal edge of the bottom wall 128, away from the side wall 126. The present disclosure is not limited thereto. In one or more embodiments of the present disclosure, the elongated opening may be provided at any suitable location, such as at a location that is offset from the microphone. As shown in FIG. 4, the microphone which is aligned with the opening 128a in the inner cover 124 is located adjacent to one of circumferential ends 132a, 132b of the cavity 132, i.e., the ends of the cavity 132 in a circumferential direction around the main body 110 of the earphone 100.

By offsetting the microphone from the elongated opening and/or placing it adjacent to one of the circumferential ends of the cavity 132, the effect of wind flowing across the earphone upon the microphone may be further reduced, resulting an improved auditory experience.

In the example shown in FIGS. 1 and 2, the earphone 100 is TWS earbuds (only one of a pair of TWS earbuds is shown). However, the present disclosure is not limited thereto, and the earphone of the present disclosure may encompass any suitable type of earphones, such as wired earbuds, neck-band earphones, or over-ear headphones.

Comparative experiments were conducted on an earphone according to the present disclosure (as shown in the figures) and a similar earphone with a smaller cavity and a 1 mm*0.5 mm opening, referred to as the “comparative earphone”. The experiments were conducted under wind speeds of 1 m/s and 3 m/s. Results showed that in the frequency band where wind noise has the greatest impact (around several hundred Hz), the wind noise picked up by the earphone of the present disclosure was about 5 dB lower than that of the comparative earphone.

According to one or more embodiments of the disclosure, the present disclosure can be implemented as follows.

Item 1: An earphone, comprising: a housing containing a speaker therein; a cavity defined within the housing; an elongated opening provided in the housing, the elongated opening communicating the cavity with an atmosphere around the earphone; and a microphone provided in the housing, the microphone being exposed to or communicating with the cavity, and being configured to capture external sound through the cavity and the elongated opening.

Item 2: The earphone of Item 1, wherein the housing comprises a main housing and a rear cover, the elongated opening is a gap or slit defined between the main housing and the rear cover.

Item 3: The earphone of any one of Items 1-2, wherein the elongated opening has a length 10 times or more greater than its width, optionally, the elongated opening has a length 20 times or more greater than its width, and still optionally, the elongated opening has a length 50 times or more greater than its width.

Item 4: The earphone of any one of Items 1-3, wherein the gap or slit has a width of 0.08-0.5 mm, 0.1-0.3 mm, or 0.15-0.25 mm.

Item 5: The earphone of any one of Items 1-4, wherein the gap or slit has a length of 8-10 mm, 7-11 mm, 6-12 mm, 9-12 mm, 12-16 mm, 16-20 mm, 20-24 mm or 24-28 mm.

Item 6: The earphone of any one of Items 1-5, wherein the gap or slit extends over an entire peripheral extension of the cavity.

Item 7: The earphone of any one of Items 1-6, wherein the earphone comprises an inner cover that is located in and attached to the housing, the inner cover comprises a concave portion, and the cavity is defined between the housing and the concave portion of the inner cover.

Item 8: The earphone of any one of Items 1-7, wherein the concave portion comprises a bottom wall and a side wall, the bottom wall comprises an opening therein, and the microphone is exposed to or communicates with the cavity through the opening in the bottom wall.

Item 9: The earphone of any one of Items 1-8, wherein the earphone comprises a main body having a front side and a rear side, the cavity is located in a peripheral area of the main body on the rear side.

Item 10: The earphone of any one of Items 1-9, wherein the cavity has a volume of about 25 mm3, a volume of 20-30 mm3, or a volume of 15-35 mm3.

Item 11: The earphone of any one of Items 1-10, wherein the cavity extends along a circumference of the main body over an angle of about 90 degrees, an angle of 80-100 degrees, or 60-120 degrees.

Item 12: The earphone of any one of Items 1-11, wherein the earphone comprises a main body and a stem extending from the main body and connected to the main body at its stem base, and the cavity extends around the stem base.

Item 13: The earphone of any one of Items 1-12, wherein the cavity and/or the elongated opening are located on a leeward side of the earphone.

Item 14: The earphone of any one of Items 1-13, wherein the elongated opening is offset from the microphone.

Item 15: The earphone of any one of Items 1-14, wherein the microphone is located adjacent to one of circumferential ends of the cavity.

Item 16: The earphone of any one of Items 1-15, wherein the microphone is an ANC microphone.

Item 17: The earphone of any one of Items 1-16, wherein the earphone is a pair of TWS earbuds.

Systems and methods have been described in general terms as an aid to understanding details of the disclosure. In some instances, well-known structures, materials, and/or operations have not been specifically shown or described in detail to prevent obscuring aspects of the disclosure. In other instances, specific details have been given to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the disclosure. Accordingly, the disclosure is not to be restricted except considering the attached claims and their equivalents.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An earphone, comprising:
a housing containing a speaker therein;
a cavity defined within the housing;
an elongated opening provided in the housing, the elongated opening communicating the cavity with an atmosphere around the earphone; and
a microphone provided in the housing, the microphone being exposed to or communicating with the cavity, and being configured to capture external sound through the cavity and the elongated opening.

2. The earphone of claim 1, wherein the housing comprises a main housing and a rear cover, the elongated opening is a gap or slit defined between the main housing and the rear cover.

3. The earphone of claim 1, wherein the elongated opening has a length 10 times or more greater than its width.

4. The earphone of claim 2, wherein the gap or slit has a width of 0.08-0.5 mm, 0.1-0.3 mm, or 0.15-0.25 mm.

5. The earphone of claim 2, wherein the gap or slit has a length of 8-10 mm, 7-11 mm, 6-12 mm, 9-12 mm, 12-16 mm, 16-20 mm, 20-24 mm or 24-28 mm.

6. The earphone of claim 2, wherein the gap or slit extends over an entire peripheral extension of the cavity.

7. The earphone of claim 1, wherein the earphone comprises an inner cover that is located in and attached to the housing, the inner cover comprises a concave portion, and the cavity is defined between the housing and the concave portion of the inner cover.

8. The earphone of claim 7, wherein the concave portion comprises a bottom wall and a side wall, the bottom wall comprises an opening therein, and the microphone is exposed to or communicates with the cavity through the opening in the bottom wall.

9. The earphone of claim 1, wherein the earphone comprises a main body having a front side and a rear side, the cavity is located in a peripheral area of the main body on the rear side.

10. The earphone of claim 1, wherein the cavity has a volume of about 25 mm3, a volume of 20-30 mm3, or a volume of 15-35 mm3.

11. The earphone of claim 1, wherein the cavity extends along a circumference of the main body over an angle of about 90°, an angle of 80-100°, or 60-120°.

12. The earphone of claim 1, wherein the earphone comprises a main body and a stem extending from the main body and connected to the main body at its stem base, and the cavity extends around the stem base.

13. The earphone of claim 1, wherein the cavity and/or the elongated opening are located on a leeward side of the earphone.

14. The earphone of claim 1, wherein the elongated opening is offset from the microphone.

15. The earphone of claim 1, wherein the microphone is located adjacent to one of circumferential ends of the cavity.

16. The earphone of claim 1, wherein the microphone is an ANC microphone.

17. The earphone of claim 1, wherein the earphone is a pair of TWS earbuds.

18. An earphone, comprising:
a housing containing a speaker therein, the housing comprises a main housing and a rear cover;
a cavity defined within the housing;
an elongated opening provided in the housing, the elongated opening communicating the cavity with an atmosphere around the earphone, the elongated opening is a gap or slit defined between the main housing and the rear cover and located on a leeward side of the earphone; and
a microphone provided in the housing, the microphone being exposed to or communicating with the cavity, and being configured to capture external sound through the cavity and the elongated opening.

19. The earphone of claim 18, wherein the microphone is an ANC microphone.

20. The earphone of claim 18, wherein the earphone is a pair of TWS earbuds.
